(19) United States
(12) Patent Application Publication
(10) Pub. No.: US 2009/0188979 A1
(43) Pub. Date: Jul. 30, 2009

(54) Laser Scanner with Synthesizable Higher Scan Rate

(76) Inventors: Gary SCHNEIDER, Stony Brook, NY (US); James Giebel, Centerport, NY (US); Peter Fazekas, Bayport, NY (US); Dariusz Madej, Shoreham, NY (US)

Correspondence Address: MOTOROLA, INC., 1303 EAST ALGONQUIN ROAD, IL01/3RD, SCHAUMBURG, IL, 60196, US

(21) Appl. No.: 12/019,400

(22) Filed: Jan. 24, 2008

(51) Int. Cl. G06K 7/10

(52) U.S. Cl. 235/462.01

(57) ABSTRACT

A method for receiving a first input signal including an analog bar pattern at a first scan rate and generating a first output signal including digital bar patterns at a second scan rate. A device having a digitizer receiving an analog bar pattern at a first scan rate and outputting, at the first scan rate, a plurality of digital bar patterns corresponding to the analog bar pattern and a processor receiving the plurality of digital bar patterns and generating a modified digital bar pattern at a second scan rate, the modified digital bar pattern including the plurality of digital bar patterns.

### FIELD OF THE INVENTION

The present invention relates generally to devices and methods for improving the performance of optical scanners. Specifically, the system and methods provide un-decoded data acquisition devices (“DADs”) with an output that corresponds to a higher scan rate than that which the DAD is actually operating without significantly impacting cost or power consumption of the DADs.

### BACKGROUND

Devices for scanning bar codes or other symbols may output un-decoded patterns or decoded patterns. Each of these types of scanning devices has benefits and drawbacks. For example, a decoding device may deliver a better image because it has better processing components to process the signal corresponding to the symbol. However, the decoding device may have a high cost and a high power consumption because of the components needed for performance of the processing of the signal. The un-decoded devices may use very little power and may be inexpensive. However, the output of the un-decoded device may not be able to be decoded because certain processing cannot be performed on the un-decoded signal. In addition, these un-decoded scanning devices generally use simple analog digitizers to convert the analog signal (e.g., analog bar pattern (“ABP”)) to a digital signal (e.g., digital bar pattern (“DBP”)), resulting in lower scan rates than other types of devices.

### SUMMARY OF THE INVENTION

A method for receiving a first input signal including an analog bar pattern at a first scan rate and generating a first output signal including digital bar patterns at a second scan rate.

A device having a digitizer receiving an analog bar pattern at a first scan rate and outputting, at the first scan rate, a plurality of digital bar patterns corresponding to the analog bar pattern and a processor receiving the plurality of digital bar patterns and generating a modified digital bar pattern at a second scan rate, the modified digital bar pattern including the plurality of digital bar patterns.

### BRIEF DESCRIPTION OF THE DRAWINGS

FIG. 1 shows an exemplary data acquisition device according to the present invention.

FIG. 2 shows a first exemplary method according to the present invention.

FIG. 3 shows the exemplary combination of signals described by the method of FIG. 2.

### DETAILED DESCRIPTION

The exemplary embodiments of the present invention may be further understood with reference to the following description and the appended drawings, wherein like elements are referred to with the same reference numerals. The exemplary embodiments of the present invention describe systems and methods for improving scanning performance. The exemplary embodiments of the present invention are related to systems and methods used for reading a symbol and outputting an un-decoded signal corresponding to the symbol. Specifically, the exemplary embodiments provide systems and methods to increase the output of a data acquisition device (“DAD”), such as a laser scanner, a two-dimensional (“2D”) imager, etc.

The exemplary embodiments of the present invention present systems and methods for improving the performance of undecoded scanners by synthesizing a higher scan rate. This may be accomplished by processing an analog scan using varying signal processing settings in order to derive multiple patterns from a single scan. It should be noted that while the exemplary embodiments of the present invention are described with reference to an undecoded DAD, it may also be possible to implement the exemplary embodiments in a decoded DAD. That is, the exemplary embodiments of the present invention may be implemented in the data collection portion of the decoded DAD prior to the portion in which the scanned symbol is decoded.

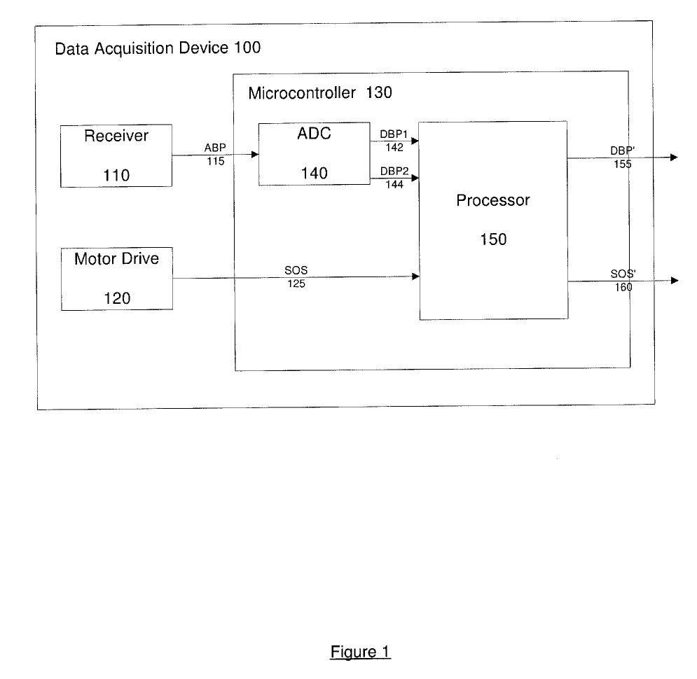

FIG. 1 illustrates an exemplary data acquisition device (“DAD”) 100 according to the present invention. It should be noted that while this disclosure describes the exemplary embodiments contained herein specifically with reference to the scanning of bar codes, the broader principles of the present invention may be equally applicable to any other type of optical scanning.

The DAD 100 includes a receiver 110, which captures the symbol data and generates an analog bar pattern (“ABP” ) 115 corresponding to the symbol in the case of scanning a bar code symbol. Image capture by the receiver 110 occurs at a first scan rate that is dependent on the hardware of the DAD 100. In one exemplary embodiment, the scan rate may be 100 scans per second. Throughout this description the exemplary value of the DAD 100 having a scan rate of 100 scans per second will be used, but those skilled in the art will understand that the DAD 100 may have any scan rate depending on the hardware implemented by the DAD 100. The exemplary embodiments of the present invention increase the output of the DAD 100 from its actual scan rate (e.g., 100 scans per second) to a higher effective scan rate as will be described in detail below.

Scanning is driven by a motor drive 120, which determines the scan rate. The motor drive 120 also outputs a start of scan (“SOS”) signal 125, which provides timing information to objects receiving output from the DAD 100. That is, in a standard undecoded DAD, the DAD will output a digital bar pattern (“DBP”) corresponding to the ABP and the SOS signal to a host device. The SOS signal is used by the host device to aid in decoding of the DBP signal. In the exemplary embodiments of the present invention, the DAD 100 will output a modified DBP′ signal 155 and a modified SOS′ signal 160 to a host device. The host device will decode the modified DBP′ signal 155 with the aid of the modified SOS′ signal 160. The generation of the DBP′ signal 155 and SOS′ signal 160 will be described in greater detail below.

The DAD 100 also includes a microcontroller 130, which may process the scanned image data according to the exemplary embodiments of the present invention. The microcontroller 130 may comprise, among other components, an analog-digital converter (“ADC”) 140 and a processor 150. The output of the ADC 140 is DBP signals 142 and 144. The generation of a DBP signal from an ABP signal is well known in the art and therefore the process will not be described herein. However, it is noted that in a standard undecoded DAD, a single DBP signal is generated from the ABP signal. In the exemplary embodiments of the present invention, multiple DBP signals are generated from the ABP signal. In the present example, two DBP signals 142 and 144 are generated. However, in other exemplary embodiments, other multiples of DBP signals may be generated. Conversion of a single ABP 115 into multiple DBPs 142 and 144 may be accomplished by varying the parameters used by the ADC 140 during the signal processing. For example, parameters varied may include digitizer thresholds, digital filtering bandwidths, margin thresholds, etc.

The DBP signals 142 and 144 are input into a processor 150 which compresses each of the DBP signals in time to create a modified DBP′ signal 155. In this example, the modified DBP′ signal 155 includes the information from both the DBP signals 142 and 144 in a single time slot, rather than the two time slots required for the original DBP signals 142 and 144. The processor 150 also modifies the SOS signal 125 to a modified SOS′ signal 160 to account for the changes in timing resulting from the time compression of the DBP signals 142 and 144.

The DBP signal compression will be described in greater detail below. However, as can be seen form the above description, the modified DBP′ 155 will be output at a rate that is greater than the scan rate of the DAD 100. For example, as described above, the scan rate of the DAD 100 may be 100 scans per second, but the output of the DAD 100 (e.g., the modified DBP′ 155) may be at a rate of 200 scans per second. It is also noted that time compression of the DBP signals is not a requirement in all instances. The DBP signals are only compressed as needed to fit the pattern into a new SOS′ timing slot.

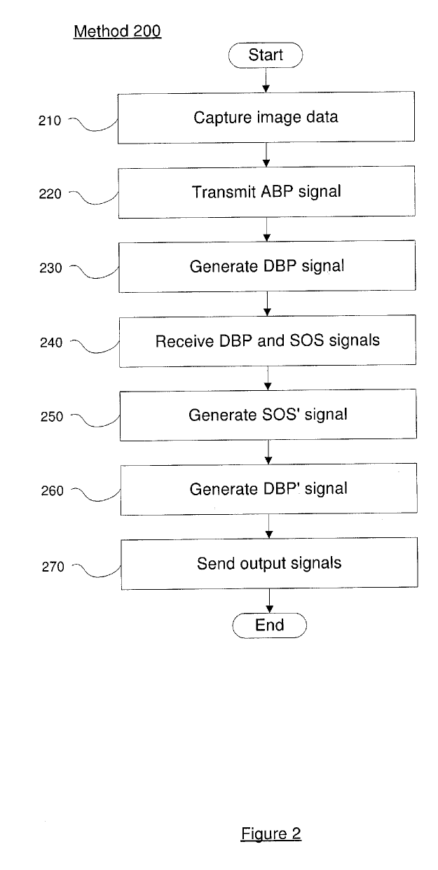

FIG. 2 illustrates an exemplary method 200 according to the present invention. While the method 200 is described specifically with reference to the device 100 of FIG. 1, those of skill in the art will understand that the method 200 may be applied by any other physical arrangement capable of capturing scan data and processing it in the method described herein.

In step 210, the receiver 110 captures data corresponding to the scanned symbol. The symbol may be a bar code, but may also be another type optical symbol that may be desirable to scan. Data capture may be, for example, at the rate of 100 scans per second. In step 220, the receiver 110 transmits the ABP signal 115 to the ADC 140, while the motor drive 120 transmits the SOS 125 to the processor 150. In step 230, the ADC converts the ABP signal 115 received from the receiver 110 to DBP signals 142 and 144.

In this exemplary embodiment, in step 230 the ADC converts each individual analog scan into two unique digital scans. Those of skill in the art will understand that in other embodiments, the ADC may convert each analog scan into three or more unique digital scans; however, such embodiments may require additional processing resources. As described above, conversion of a single ABP 115 into multiple DBPs 142 and 144 may be accomplished by varying the parameters used by the ADC 140 during the signal processing. For example, parameters varied may include digitizer thresholds, digital filtering bandwidths, margin thresholds, etc. In some embodiments of the present invention, only one of these parameters may be varied in order to generate multiple digital scans from a single analog scan; in others, two or more parameters may be varied. In some exemplary embodiments, the variance of parameters may be selected to generate usable digital signals for specific types of analog signals (e.g., clean signals, noisy signals, dark signals, etc.).

In step 240, the processor 150 receives the DBP signals 142 and 144 and the SOS signal 125. At this point, the SOS signal 125 is still at the initial scan rate (e.g., as discussed above, 100 scans per second). However, two DBP signals 142 and 144 have been generated from an ABP signal 115 that was originally at the same initial scan rate. Thus, in order to generate properly timed outputs, in step 250 the processor 150 generates a new SOS′ signal 160 that is at an increased rate from the original SOS signal 125. Those of skill in the art will understand that in this exemplary embodiment, wherein two DBP signals 142 and 144 are generated from an ABP signal 115, the SOS′ signal 160 will be twice the rate of the SOS signal 125, while in other embodiments in which more DBPs may be generated from one ABP, the increase in rate from the SOS signal 125 to the SOS′ signal 160 will vary accordingly. Thus, if the rate of the original SOS signal 125 is 100 scans per second, as described above, then the rate of the SOS′ signal 160, which may be used for timing purposes, may be 200 scans per second.

In step 260, the processor 150 merges the DBP signals 142 and 144 into a combined DBP′ signal 155. The signals 142 and 144 are time-compressed to enable transmission at a faster rate. Information in a bar code in encoded by means of widths of bars and spaces. However it is not absolute widths that carry the information, but relative widths. For example, the ratio of the width of any given element to a narrowest element. Thus, it is possible to generate a first DBP pattern (P1) that is equivalent, from the information content point of view, to a second DBP pattern (P2) that yields the same symbol. However, P2 may be compressed in time, meaning that impulses representing bars and spaces are shorter. Because a DBP signal can be compressed in time, it is possible to send several (k) sets of DBP in the time slot of one scanline instead of just one, resulting in an effective scan rate of k times the rate of the opto-mechanical components of the DAD.

Thus, in the present example, each of the DBPs 142 and 144 may be compressed into a time slot of a single scanline DBP (e.g., either DBP 142 or DBP 144). In this manner, sending the combined DBPs 142 and 144 as DBP′ 155 results in the DAD 100 having an effective scan rate that is equivalent to twice the actual opto-mechanical scan rate of the DAD 100. This will also result in a higher probability of decoding by a host device receiving the DBP′ 155 because twice as much data is being provided to the host device.

It should be noted that the steps 250 and 260 of the method 200 may be inverted. That is, the processor 150 may first combine the DBP signals 142 and 144 into the modified DBP′ signal 155 and then convert the SOS signal 125 into the modified SOS′ signal 160.

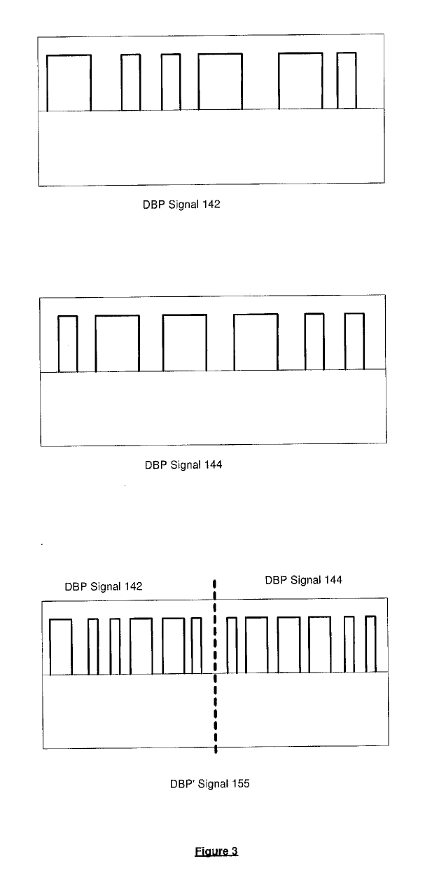

FIG. 3 illustrates an exemplary combination of the DBP signals 142 and 144 into the modified DBP′ signal 155. As described above, the DBP signals 142 and 144 may be derived from the same scanline data collected by the DAD 100. For example, the DBP signals 142 and 144 may be derived from the same ABP signal using different settings for the digitizer. Thus, the top portion of FIG. 3 shows the DBP 142 at a scan rate of 100 scans per second. The middle portion of FIG. 3 shows the DBP 144 at a scan rate of 100 scans per second. The bottom portion of FIG. 3 shows the modified DBP′ 155 that includes the time compressed DBP 142 and the time compressed DBP 144, resulting in an effective scan rate of 200 scans per second. In addition to compressing and combining the DBP signals 142 and 144, the microcontroller 130 also needs to adjust the SOS signal 125 that is set for 100 scans per second to SOS′ 160 that is set for 200 scans per second.

In step 270, the processor sends the DBP′ signal 155 and the SOS′ signal 160 as outputs. As those of skill in the art will understand, the purpose of the modified SOS′ signal 160 may be to provide timing information for an external device that may be receiving the DBP′ signal 155 as a signal input, and thus aid in interpreting the DBP′ signal 145.

The exemplary embodiments of the present invention may make it possible to synthesize a higher scan rate than would normally be possible for a scanner that uses an analog capture mechanism. Because this may be accomplished using a processor that may already be present in order to accomplish other tasks, no additional space is required in the scanning device, nor does any increase in cost result. Further, because no increase in the actual physical image capture rate is required, there is no increase in power consumption.

Additionally, as described above, digitizing parameters may be varied and set in manners that are selected specifically to compensate for specific types of signals (e.g., clean signals, noisy signals, dark signals, etc.). By doing so, by thus automatically digitizing a single analog signal using, for example, both a set of parameters that are appropriate for digitizing noisy signals and a set of parameters that are appropriate for digitizing clean signals, the likelihood of digitizing an analog signal into a usable digital signal without user intervention may be increased.

Those skilled in the art will understand that the above described exemplary embodiments may be implemented in any number of manners, including as a separate software module, as a combination of hardware and software, etc. For example, the method 200 may be performed by a program containing lines of code that, when compiled, may be executed on a processor.

The present invention has been described with reference to the above specific exemplary embodiments. However, those of ordinary skill in the art will recognize that the same principles may be applied to other embodiments of the present invention, and that the exemplary embodiments should therefore be read in an illustrative, rather than limiting, sense.

What is claimed is:

1. A method, comprising:
receiving a first input signal including an analog bar pattern at a first scan rate; and
generating a first output signal including digital bar patterns at a second scan rate.

2. The method of claim 1, further comprising:
receiving a second input signal including first timing information corresponding to the first scan rate; and
generating a second output signal including second timing information corresponding to the second scan rate.

3. The method of claim 1, wherein the first scan rate is greater than 50 scans per second.

4. The method of claim 1, wherein the second scan rate is greater than the first scan rate.

5. The method of claim 4, wherein the second scan rate is a whole number multiple of the first scan rate.

6. The method of claim 1, wherein the generating the first output signal includes:
generating a plurality of digital bar patterns corresponding to the analog bar pattern.

7. The method of claim 6, wherein the digital bar patterns are generated by varying a parameter of a signal processing of the analog bar pattern.

8. The method of claim 7, wherein the parameter is one of a digitizer threshold, a digital filter bandwidth, a digitizer algorithm, a margin threshold.

9. The method of claim 7, wherein the parameter is varied to compensate for a defect in the analog bar patterns.

10. The method of claim 1, wherein the first input signal corresponds to a single scan line.

11. A device, comprising:
a digitizer receiving an analog bar pattern at a first scan rate and outputting, at the first scan rate, a plurality of digital bar patterns corresponding to the analog bar pattern; and
a processor receiving the plurality of digital bar patterns and generating a modified digital bar pattern at a second scan rate, the modified digital bar pattern including the plurality of digital bar patterns.

12. The device of claim 11, wherein the processor further receives an input signal including first timing information corresponding to the first scan rate and generates an output signal including second timing information corresponding to the second scan rate.

13. The device of claim 11, further comprising:
a receiver generating the analog bar pattern based on scanning a symbol.

14. The device of claim 12, further comprising:
a motor drive generating the input signal including the first timing information.

15. The device of claim 11, wherein the first scan rate is greater than 50 scans per second.

16. The device of claim 11, wherein the second scan rate is greater than the first scan rate, the second scan rate being a whole number multiple of the first scan rate.

17. The device of claim 11, wherein the digitizer generates the plurality of digital bar patterns by varying a parameter of a signal processing of the analog bar pattern.

18. The device of claim 17, wherein the parameter is one of a digitizer threshold, a digital filter bandwidth and a margin threshold.

19. The device of claim 11, wherein the analog bar pattern corresponds to a single scan line.

20. The device of claim 11, wherein the generating of the modified digital bar pattern by the processor includes time compressing the plurality of digital bar patterns.

21. A computer readable storage medium including a set of instructions executable by a processor, the instructions operable to:
receive a first signal including a plurality of analog bar patterns at a first rate;
convert each of the plurality of analog bar patterns into two or more digital bar patterns; and
generate a second signal including the digital bar patterns at a second rate.

22. A device, comprising:
a means for receiving an analog bar pattern at a first scan rate and outputting, at the first scan rate, a plurality of digital bar patterns corresponding to the analog bar pattern; and
a means for receiving the plurality of digital bar patterns and generating a modified digital bar pattern at a second scan rate, the modified digital bar pattern including the plurality of digital bar patterns.
